(19) United States
(12) Patent Application Publication
(10) Pub. No.: US 2003/0027572 A1
(43) Pub. Date: Feb. 6, 2003

(54) Method and system for primary paging location of mobile terminal

(75) Inventors: Bernt Karlsson, Sollentuna (SE); Niklas Gustafsson, Linkoping (SE)

Correspondence Address: Steven R. Greenfield, Jenkens & Gilchrist, P.C., 3200 Fountain Place, 1445 Ross Avenue, Dallas, TX, 75202-2799, US

(73) Assignee: Telefonaktiebolaget L M Ericsson (publ)

(21) Appl. No.: 09/922,988

(22) Filed: Aug. 3, 2001

(51) Int. Cl. H04Q 7/20

(52) U.S. Cl. 455/433; 455/458; 455/432

(57) ABSTRACT

The present invention is directed to a method and system for producing and storing “roaming” area information of a mobile terminal in a home location register or guest location register. A “roaming” area includes a group of location areas within a single service area. When a mobile terminal enters a new location area within a new roaming area or enters a new service area, the home location register (HLR) or guest location register (GLR) is updated with the roaming area information of the mobile terminal. The HLR/GLR stores this information in addition to the other information typically stored for the mobile terminal. If an MSC/VLR system restart and reload occurs or another event such that the location area information is lost, the roaming area information can be retrieved from the HLR/GLR. Likewise, if the mobile terminal does not respond to a page within the location area stored for the mobile terminal, the roaming area information can be retrieved from the MSC/VLR. Thereafter, the roaming area information can be used by the MSC/VLR to perform a primary page for a mobile terminal within the roaming area, instead of a global page within the service area, thus reducing paging congestion in the network.

### BACKGROUND OF THE INVENTION

1. Field of the Invention

The present invention is related to mobile communications networks and, more particularly, to a method and system for locating a roaming mobile terminal in a mobile communications network through primary paging thereof

2. Description of the Related Art

A typical mobile communications network is made of a number of predefined geographical service areas, also known as control areas. Within each service area are a plurality of location areas. Each location area includes one or more cells, each having a base station therein for providing radio coverage to the cell for which it is responsible. When a mobile terminal is paged (i.e., due to an incoming call), the page is broadcast in all cells within the location area the mobile terminal is located in.

The location area further defines an area in which a mobile terminal may move about freely without having to update the network as to the location of the mobile terminal. However, if the mobile terminal moves to a different location area or a different service area, then the network must be apprised of the movement including information about the new location area and/or service area.

Referring now to FIG. 1A, a relevant portion of a typical mobile communications network 100 is shown. The network 100 includes a first mobile switching center-A/visitor location register (MSC-A/VLR) 102A and a second mobile switching center-B/visitor location register (MSC-B/VLR) 102B. The service or control area of the MSC-A/VLR 102A includes a plurality of location areas, two of which are shown here at LA1 (blank area) and LA2 (shaded area). Likewise, the service or control area of the MSC-B/VLR 102B includes location areas LA3 (shaded area) and LA4 (striped area). As discussed above, each of the roaming areas LA1-LA4 includes a number of smaller cells, examples of which are denoted C1-C3.

The MSCs and VLRs, and the operation thereof, are well known to those of ordinary skill in the art and will not be described in detail here. Briefly, the MSC-A and MSC-B control the routing of calls to and from the mobile terminals located in the location areas LA1-LA4, respectively, and the VLRs temporarily store subscriber information used by the MSC-A and MSC-B to properly route the calls. Note that the MSCs and VLRs are shown here in integrated form for convenience purposes only and it is not necessary that they always be so integrated.

The network 100 also includes a database 108 for providing long term storage of information about the mobile terminals that subscribe to the communications services provided by the network 100. The types of information stored by the database 108 include International Mobile Subscriber Identity (IMSI) and Mobile Subscriber Identity (MSI) numbers, which uniquely identify subscribers within a Public Land Mobile Network (PLMN), various authentication parameters, subscription services, and other types of information needed to identify and service the mobile terminals. It should be understood that the IMSI consists of a Mobile Country Code (MCC), Mobile Network Code (MNC) and Mobile Subscriber Identification Number (MSIN) and the MSI includes only the MNC and MSIN. The database 108 may be referred to as a home location register (HLR) in some mobile communication systems such as the Global System for Mobile Communication (GSM). A Guest Location Register (GLR) serves essentially the same function for mobile terminals that are visitors to some communication systems such as the Personal Digital Communication (PDC) system of Japan.

Consider a typical scenario where a mobile terminal 110 moves from the service area of MSC-B/VLR 102B into the service area of the MSC-A/VLR 102A, for example, from LA3 into LA1. The MSC-A/VLR 102A detects the mobile terminal 110 and begin a procedure to register the mobile terminal in the service area thereof The registration procedure includes a number of steps, e.g., recording the location area information of the mobile terminal and notifying the HLR/GLR 108 that the mobile terminal 110 is now located in the MSC-A/VLR's service area. The HLR/GLR 108, in turn, records the service area information and provides the MSC-A/VLR 102A with identifying and servicing information about the mobile terminal 110. The HLR/GLR 108 further notifies MSC-B/VLR 102B that the mobile terminal has left its service area. Incoming calls for the mobile terminal 110 are then routed to the service area of the MSC-A/VLR 102A, which then routes the calls to the mobile terminal 110 in LA1.

The mobile terminal 110 may move anywhere within LA1, for example, to another cell C1, and no update of its location need be provided to either the MSC-A/VLR 102A or the HLR/GLR 108. This is because the service area and location area are already known by the MSC-A/VLR 102A and HLR/GLR 108, respectively, from the initial registration. However, if the mobile terminal 110 were to subsequently move to a cell belonging to a different roaming area, for example, cell C2 in LA2, then the MSC-A/VLR 102A would have to be updated with the new location area so that calls may be routed to the mobile terminal 110 appropriately. Such an update is commonly referred to as an “intra-service location area registration.”

At this point, the HLR/GLR 108 does not yet need to be updated because the mobile terminal 110 is still located in the same service area of the MSC-A/VLR 102A. Only when the mobile terminal 110 moves to an entirely different service area, such as cell C3 in LA3 does the HLR/GLR 108 need to be updated. In this case, the MSC-B/VLR 102B records the location area information for LA3 and notifies the HLR/GLR 108 that the mobile terminal 110 is now in its service area. This update is commonly referred to as an “inter-service area registration.” The HLR/GLR 108 then sends identifying and servicing information for the mobile terminal 110 to the MSC-B/VLR 102B. Incoming calls to the mobile terminal 110 are thereafter routed to the service area of the MSC-B/VLR 102B, which subsequently routes the call to the mobile terminal 110 in LA3.

Consider now the case where the MSC-A/VLR 102A experiences a “large” restart and reload, either unexpectedly or otherwise, while the mobile terminal 110 is located in the location area LA1. Such a restart and reload may cause all of the MSC-A/VLR's information about the mobile terminal 110, including the location area thereof, to be lost. If the mobile terminal 110 remains in location area LA1 during this time and does not move outside, no update of the subscriber data in the MSC-A/VLR 102A takes place for the reason explained above, and the MSC-A/VLR 102A is ignorant of the location of the mobile terminal 110 because this information has been lost. Hence, when a call comes for the mobile terminal 110, the MSC-A/VLR 102A does not know to which of the plurality of location areas it should route the call. The HLR/GLR 108 likewise does not know to which location area the call should be routed because it stores only the service area information.

In such a case, the MSC-A/VLR 102A has to issue a global page for the mobile terminal 110, which is a page broadcasted to all location areas within the service area. However, global pages consume a tremendous amount of resources both in terms of bandwidth and processing power relative to a primary page, which is a page broadcasted to a particular location area only. Moreover, if an unplanned system restart and reload occurred during peak traffic hours, the amount of paging congestion in the system may be increased by up to 75%, resulting in extended delays for incoming calls that may cause some callers to simply give up.

By way of example, a service area having 500 cells wherein there are no overlapping location areas has to send about 500 pages simultaneously in order to globally page one mobile terminal. If overlapping location areas are used, the total number of pages may increase by up to 4 or 5 times. For example, such overlapping location areas are illustrated in FIG. 1B. A plurality of cells C1-C12 are shown in FIG. 1B. Cells C1, C3, C6, C8 and C11 belong only to LA1 (illustrated by the striped cells) and cells C2, C5, C7, C10 and C12 belong only to LA2 (illustrated by the clear cells). However, cells C4 and C9 (shown as dotted cells) belong to both LA1 and LA2, since the borders B1 and B2 of LA1 and LA2, respectively, overlap. Thus, cells C4 anc C9 handle paging for both LA1 and LA2. Networks that implement overlapping location areas process fewer location registrations. However, there is increased paging within the overlapped cells due to overlapped paging between LA1 and LA2.

Therefore, it is desirable to provide a way to reduce the amount of congestion within a service area due to global pages after an MSC/VLR system restart and reload. More particularly, it is desirable to provide a way to store additional area information of the mobile terminal so that the information can be restored when such a system restart and reload occurs.

### SUMMARY OF THE INVENTION

The present invention is directed to a method and system for storing “roaming” area information of a mobile terminal in a home location register or guest location register. A “roaming” area includes a group of location areas within a single service area. When a mobile terminal enters a new location area belonging to a new roaming area or enters a new service area, the home location register or guest location register is updated with the new roaming area of the mobile terminal. The home location register or guest location register stores this information in addition to the other information typically stored for the mobile terminal. If an MSC/VLR system restart and reload occurs such that the location area information is lost, the roaming area information can be retrieved from the home location register or guest location register and used to determine the location area of the mobile terminal. For example, a primary page may be issued for the mobile terminal within the roaming area, and only if the primary page fails, a global page may be issued.

In one aspect, the invention relates to a method of locating a mobile terminal in a mobile communications network. The method comprises the steps of detecting when the mobile terminal has entered a new roaming area, obtaining a roaming area information of the new roaming area, storing the roaming area information in a database, and primary paging the mobile terminal using the roaming area information stored in the database.

In another aspect, the invention relates to a system for locating a mobile terminal in a mobile communications network. The system comprises a mobile switching center adapted to detect when the mobile terminal has entered a new roaming area and to obtain a roaming area information of the new roaming area. The system also comprises a database connected to the mobile switching center and configured to store the roaming area information. The mobile switching center is further adapted to issue a primary page for the mobile terminal using the roaming area information stored in the database.

In a further aspect, the invention relates to an adaptive roaming area system, in which roaming areas overlap each other such that each roaming area overlaps 50% of neighboring roaming areas. Therefore, there are as many roaming areas as there are location areas. When the mobile terminal enters a new location area within a new roaming area, the mobile terminal will be located in the middle of the new roaming area. The location area of the mobile terminal is sent to the home location register for storage therein. This location area is used by the MSC to determine the roaming area for primary paging.

### BRIEF DESCRIPTION OF THE DRAWINGS

A more complete understanding of the method and apparatus of the present invention may be had by reference to the following detailed description when taken in conjunction with the accompanying drawings wherein:

FIGS. 1A and 1B illustrate an exemplary mobile communications network;

FIG. 2 illustrates a method and system according to one embodiment of the present invention;

FIGS. 3A-3B illustrate MAP subscriber data messages according to the embodiment shown in FIG. 2;

FIG. 4 illustrates a method and system according to another embodiment of the present invention;

FIGS. 5A-5B illustrate MAP update subscriber data messages according to the embodiment shown in FIG. 4;

FIGS. 6A-6B illustrate a method and system according to another embodiment of the present invention;

FIG. 7A illustrates a MAP terminating call routing retrieval message and FIGS. 7B-7C illustrate MAP terminating call routing messages according the embodiments shown in FIGS. 6A-6B;

FIGS. 8A-8B illustrate ISUP IAM messages according to the embodiments shown in FIGS. 6A-6B; and

FIG. 9 illustrates a method and system according to another embodiment of the present invention.

### DETAILED DESCRIPTION OF THE EXEMPLARY EMBODIMENTS

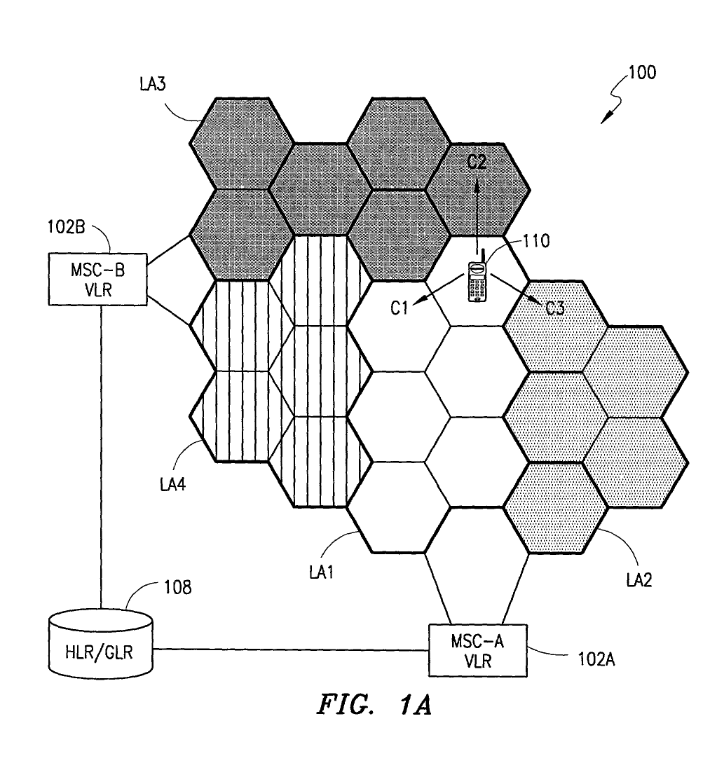

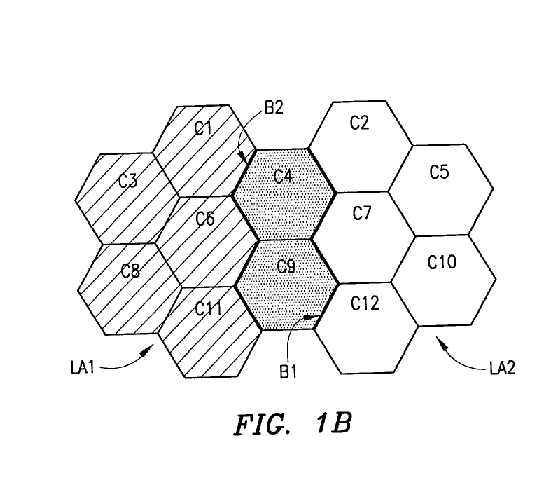

The various embodiments of the present invention and its advantages are best understood by referring to FIGS. 1-8 of the drawings, wherein like numerals refer to like and corresponding parts.

Embodiments of present invention provide a method and system for storing “roaming” area information of a mobile terminal in the HLR/GLR. A “roaming” area includes a group of location areas within a single service area. When the mobile terminal moves to a different location area or a different MSC/VLR service area, the mobile terminal updates the network with the new location area and/or service area. If the new location area belongs to a different roaming area, the network updates and stores the new roaming area of the mobile terminal. Therefore, the roaming area information may be restored from the HLR/GLR after an MSC/VLR system restart and reload or as needed otherwise.

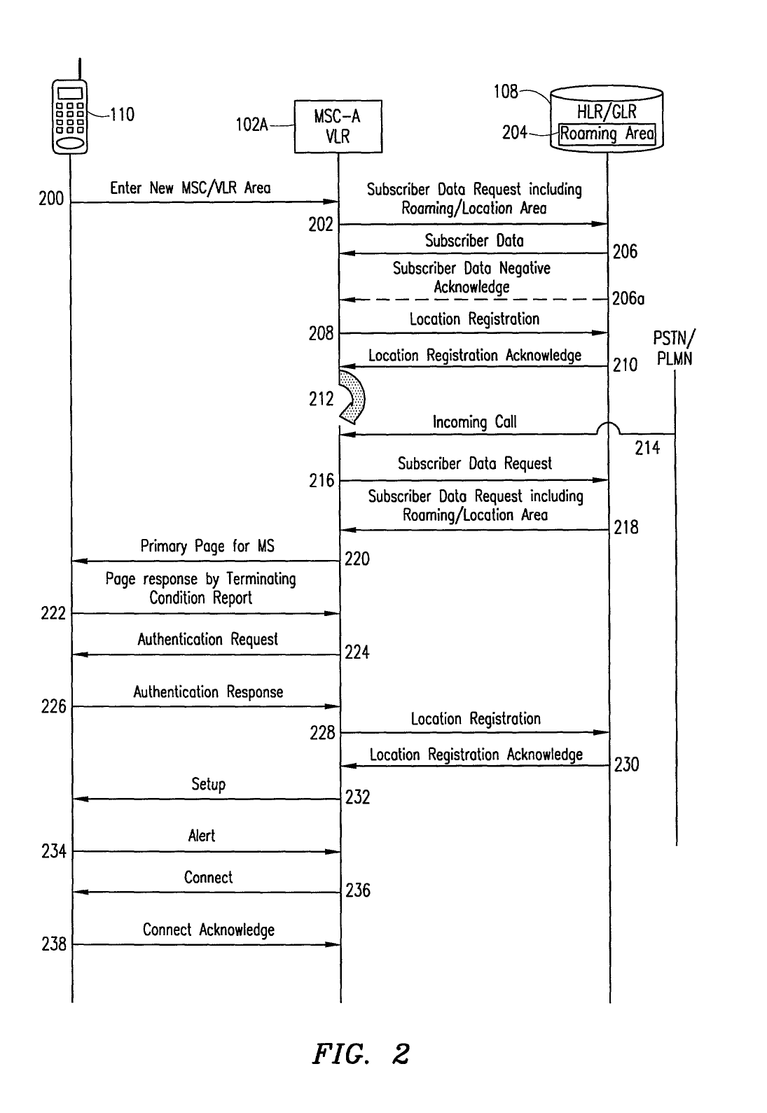

Referring now to FIG. 2, an exemplary embodiment of the present invention is shown wherein the mobile terminal 110 is being registered to a new service area, i.e., an inter-service area registration. It should be emphasized that only the very basic steps (for some successful registration cases, fault cases being excluded) of the registration process are shown in FIG. 2 and throughout the drawings for economy purposes, and additional steps may be added in other embodiments as needed without departing from the scope of the invention.

At step 200, the mobile terminal 110 moves into a new service area served by MSC-B/VLR 102B. Upon entering the new location area within the new service area, the mobile terminal 110 detects that a different location area identity (LAI) is now being broadcasted on the control channel in the service area, for example, on the broadcast control channel (BCCH). The mobile terminal 110 cannot determine whether it has moved into a location area belonging to the same service area or a different service area. It can only detect that the current LAI has changed relative to the LAI it was receiving before. At this point, the mobile terminal 110 sends a Location Registration Request message to the MSC-B/VLR 102B including, for example, at least the mobile subscriber identity (MSI) therefor.

At step 202, the MSC-B/VLR 102B recognizes from the MSI information that the mobile terminal 110 is a new visitor to its service area, and has not yet been registered therein. Based on the LAI received from the mobile terminal 110, the MSC-B/VLR 102B determines the associated roaming area. For example, the MSC-B/VLR 102B can have a database therein for storing a table correlating LAI's with their associated roaming areas.

The MSC-B/VLR 102B then sends a subscriber data request message to the HLR/GLR 108 to request information about the mobile terminal 110. Included in the data request message, according to one exemplary embodiment, is the roaming area information 204 determined by the MSC-B/VLR 102B for the mobile terminal 110. This roaming area information 204 is subsequently received by and stored in the HLR/GLR 108. Thus, in accordance with this exemplary embodiment, each time a mobile terminal undergoes an inter-service area registration, the roaming area information 204 therefor is sent to and stored in the HLR/GLR 108.

At step 206, the HLR/GLR 108 sends the requested subscriber data to the MSC-B/VLR 102B (e.g, the MSI, various authentication parameters, subscription services, etc.). The MSC-B/VLR 102B checks this authentication information against the information received from the mobile terminal 110. If there is agreement, then the MSC-B/VLR 102B registers the location of the mobile terminal 110 with the HLR/GLR 108 at step 208. A location registration acknowledgment message is sent from the LR/GLR 108 to the MSC-B/VLR 102B at step 210. The mobile terminal 110 is now registered in this new service area of the MSC-B/VLR 102B, and incoming calls may thereafter be properly routed thereto.

Alternatively, a subscriber data negative acknowledgment message may be sent instead of the regular subscriber data message, as shown by a dashed line at step 206a. Such a negative acknowledgment message may be sent in the case where the service plan of mobile terminal 110 is a location based plan that includes only a limited service area, and the mobile terminal 110 has ventured outside this area. In that case, the HLR/GLR 108 may still provide the requested data, but the MSC-B/VLR 102B is notified that the mobile terminal 110 is outside its subscribed service area.

Occasionally, as shown at 212, the MSC-B/VLR 102B undergoes a “large” type system restart and reload, either planned or otherwise, that wipes out all current information about the mobile terminal 110 stored locally in the MSC-B/VLR 102B, including the location area and, hence, the roaming area information thereof.

At step 214, an incoming call from a PSTN or PLMN for the mobile terminal 110 is received by the MSC-B/VLR 102B. Because the registration information for the mobile terminal 110 has been lost, the MSC-B/VLR 102B does not know where to route the call and must request this information again from the HLR/GLR 108. Thus, at step 216, the MSC-B/VLR 102B issues another subscriber data request message to the HLR/GLR 108. At step 218, the HLR/GLR 108 sends the subscriber data including identifying and servicing information (e.g., MSI, etc.) for the mobile terminal 110 to the MSC-B/VLR 102B. This information alone, however, is normally not enough for the MSC-B/VLR 102B to properly route the call because the roaming area information for the mobile terminal 110 is still unknown. Therefore, in accordance with the principles of the present invention, the subscriber data sent from the HLR/GLR 108 may also include the roaming area information 204.

Loaded now with the roaming area information 204, the MSC-B/VLR 102B can issue a primary page for the mobile terminal 110 at step 220 instead of the global page that would otherwise have to be issued if the roaming area information 204 was not available. The mobile terminal 110 can thereafter respond to the primary page using a page response procedure including sending a terminating condition report to the MSC-B/VLR 102B at step 222.

Once the mobile terminal 110 has responded to the primary page, the MSC-B/VLR 102B authenticates the mobile terminal by requesting authentication information therefrom at step 224. If the authentication information from the mobile terminal 110 (step 226) is in agreement with that of the MSC-B/VLR 102B, the re-registration process can be completed at steps 228 and 230.

The incoming call may thereafter be set up by the MSC-B/VLR 102B at step 232, to which the mobile terminal 110 may respond by issuing an alert message at step 234. The call may then be connected by the MSC-B/VLR 102B at step 236, followed by a connection acknowledgment message from the mobile terminal at step 238.

As mentioned above, the roaming area information may be sent to the HLR/GLR 108 as part of a subscriber data request message. Such a subscriber data request message may be implemented in any form suitable for the purpose. Likewise, the roaming area information 204 included in the subscriber data request message may take any form including numbers, letters, or combination thereof that can identify the particular roaming area within the service area of the mobile terminal. In an exemplary embodiment, the subscriber data request message is implemented as a mobile applications protocol (MAP) subscriber data request message. MAP-based messages and their contents are generally known to those of ordinary skill in the art and, therefore, will not be described in detail here. Briefly, such MAP-based messages may be used in a number of mobile communication systems including the GSM system and the PDC system mentioned previously.

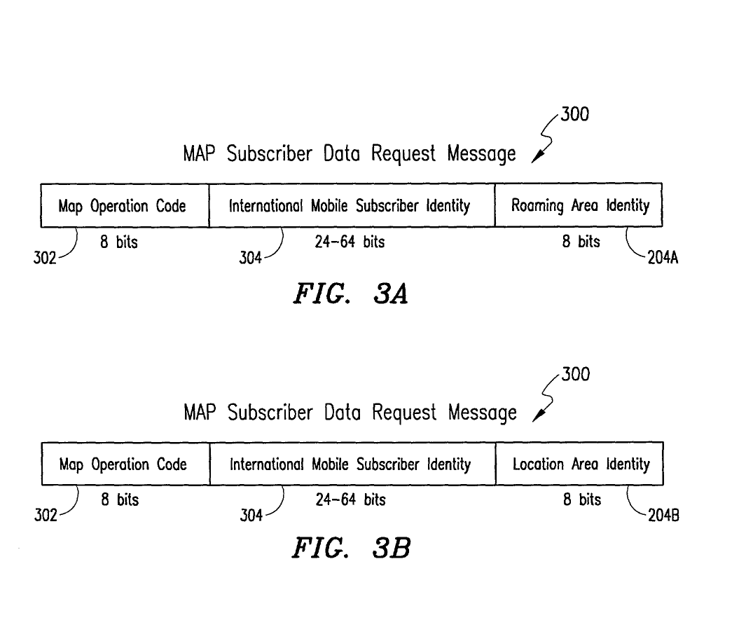

FIGS. 3A and 3B illustrate exemplary embodiments of a MAP-based subscriber data request message 300. The MAP-based subscriber data request message 300 includes 8 bits of MAP operation code 302, 24-64 bits of IMSI 304, and 8 bits of roaming area information 204. In FIG. 3A, for example, the roaming area information 204 may be realized as a Roaming Area Identity 204A which is included in the MAP-based subscriber data request message 300. Such a Roaming Area Identity 204A may be a unique number that indicates the particular roaming area where the mobile terminal is located.

Alternatively, in FIG. 3B, the roaming area information 204 may be realized as Location Area Identity (LAI) 204B. Such a LAI 204B may also be a unique number that indicates the particular location area in the roaming area of the service area where the mobile terminal is located.

Although not expressly shown, the acknowledgment messages in steps 206 and 206a may also be implemented using MAP-based messages such as a MAP-based subscriber data acknowledgment message and MAP-based subscriber data negative acknowledgment message, the contents of which are simply the MAP operation codes for acknowledgment.

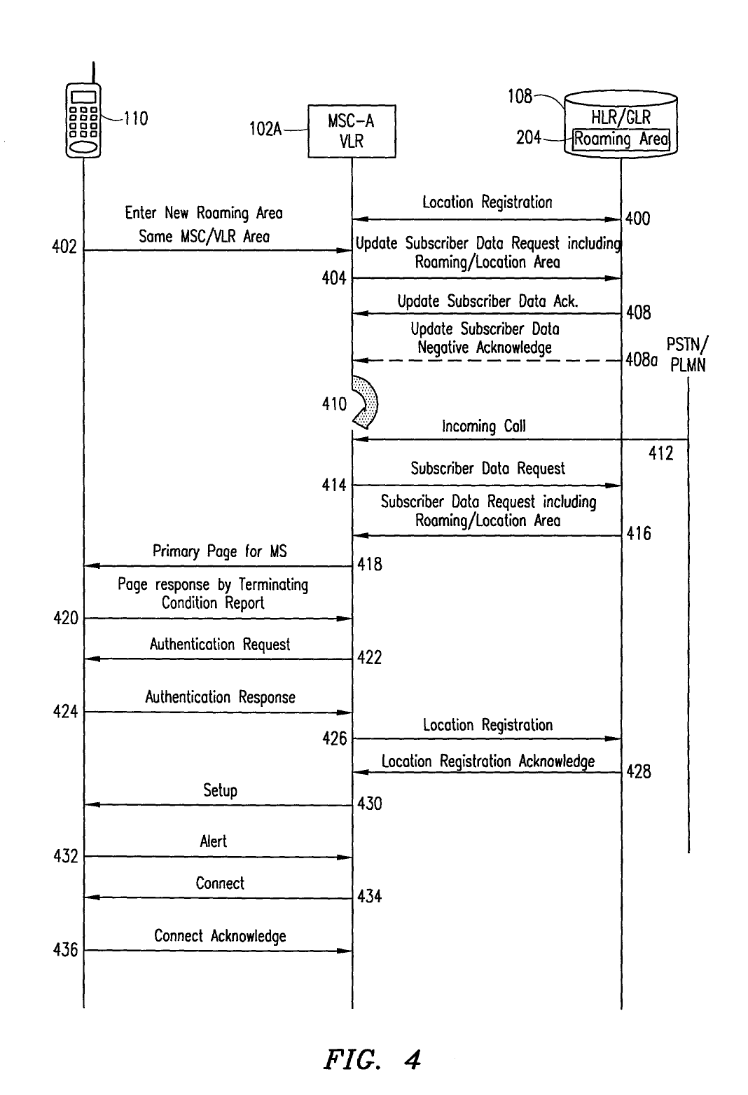

FIG. 4 illustrates an exemplary embodiment of the present invention wherein the mobile terminal 110 is registered into a new location area of the same service area, also known as an intra-service area registration. In this case, the mobile terminal 110 will have already completed the location registration process at step 400 for the service area as specified in FIG. 2 steps 202-210. At step 402, the mobile terminal 110 enters into the new location area administered by the MSC-A/VLR 102A. Upon entering the new location area, the mobile terminal 110 detects that a different location area identity (LAI) is being broadcasted on the BCCH in the service area. The mobile terminal 110 sends a location update request message to the MSC-A/VLR 102A including at least the mobile subscriber identity (MSI) therefor.

Because the MSC-A/VLR 102A recognizes from the MSI that the mobile terminal 110 is already registered in its service area, it does not need to request subscriber data from the HLR/GLR 108. However, the MSC-A/VLR 102A does internally or locally update itself with the new location area information of the mobile terminal 110. In addition, the MSC-A/VLR 102A also determines whether the new LAI is within a new roaming area (e.g., by accessing the table of LAI's and correlated roaming area information). If the new location area is also within a new roaming area, at step 404, the MSC-A/VLR 102A sends an update subscriber data message that includes the new roaming area information 204 of the mobile terminal 110 to the HLR/GLR 108. This new roaming area information 204 is subsequently received by and stored in the HLR/GLR 108.

In some embodiments, the HLR/GLR 108 may respond to the update subscriber data message by sending an update subscriber data acknowledgment message at step 408. However, where the mobile terminal 110 has ventured outside its subscribed service area, the HLR/VLR 108 may send an update subscriber data negative acknowledgment message instead at step 408a. Recall that a negative acknowledgment message may be sent in the case where the service plan of mobile terminal 110 is a location based plan that includes only a limited service area.

The remaining steps own in FIG. 4, beginning with the large type system restart and reload indicated at 410, are essentially identical to their counterparts in FIG. 2 and, therefore, will not be described again here. It should be understood that the roaming area information 204 may be used under any circumstances where the network has lost the location area information for the mobile terminal, or the mobile terminal does not respond to a location area page. In those cases, the network broadcasts the page within the roaming area that the mobile terminal is located in.

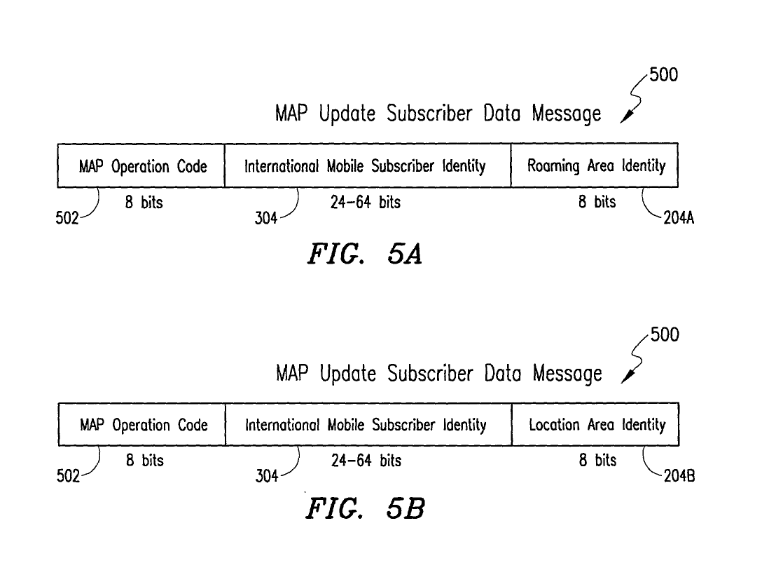

The update subscriber data message sent by the MSC-A/VLR 102A in step 404 may assume any suitable form, but in an exemplary embodiment, the message is a MAP-based update subscriber data message. Illustrated in FIGS. 5A and 5B are exemplary embodiments of a MAP-based update subscriber data message 500 including 8 bits of MAP operation code 502, 24-64 bits of IMSI 304, and 8 bits of roaming area information 204. In FIG. 5A, for example, the new roaming area information is realized as a Roaming Area Identity 204A of the particular roaming area where the mobile terminal 110 is located. Alternatively, in FIG. 5B, the new roaming area information is realized as a Location Area Identity (LAI) 204B for the particular location area of the roaming area of the service area where the mobile terminal is located.

The acknowledgment messages in steps 408 and 408a, like those of steps 206 and 206a (FIG. 2), may also be implemented using MAP-based messages such as a MAP-based update subscriber data acknowledgment message and MAP-based update subscriber data negative acknowledgment message.

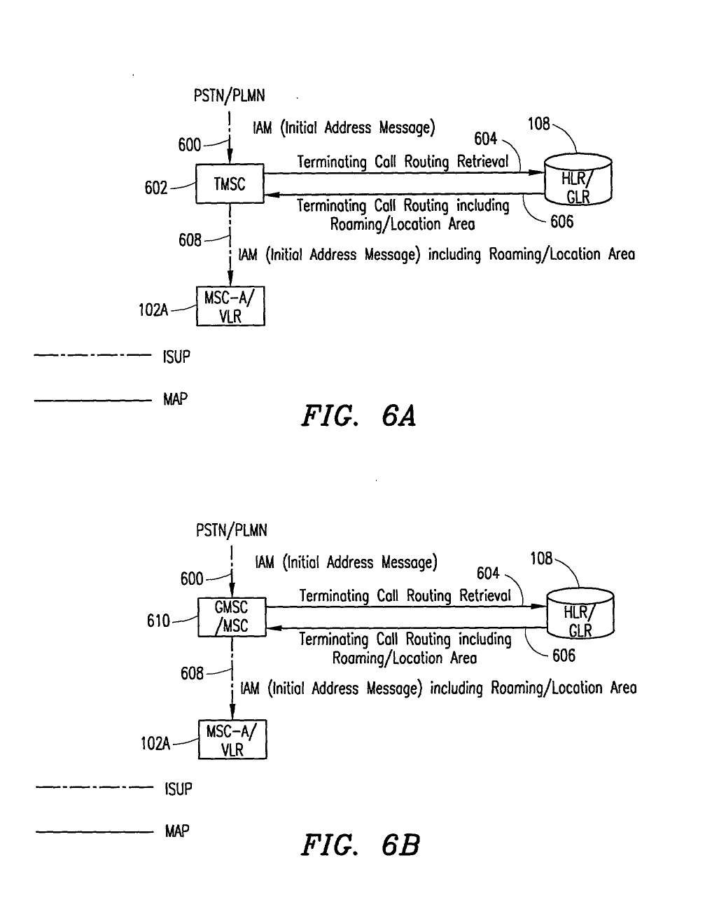

In some embodiments, roaming area information may be included with the call routing information obtained from the HLR/GLR for every incoming call, as shown in FIGS. 6A and 6B. Such an arrangement may be very useful during the time shortly after an MSC/VLR restart and reload has occurred when the location area information is missing for most of the mobile terminals in the service area of the MSC/VLR. For example, when an incoming call is received, the HLR/GLR provides not only the standard call routing information, but also the roaming area information. The HLR/GLR may continue to include the roaming area information with the call routing information for a sufficient period of time, say, a few days. Once the roaming area information becomes known to the MSC/VLR again for the various mobile terminal, it is no longer necessary for the HLR/GLR to continue including this information with every incoming call.

Assume in FIG. 6A that a restart and reload has very recently occurred in, for example, the MSC-A/VLR 102A, and the location area information, hence, the roaming area information for the mobile terminals 110 therein have been lost. For each incoming call, information regarding the incoming call is sent (dashed line) by the PSTN or PLMN via an ISUP (ISDN User Part) message called an initial address message (IAM) 600. The IAM is sent to a Transit MSC (TMSC ) 602, which thereafter requests call routing information from the HLR/GLR 108 via a terminating call routing retrieval message 604. In accordance with one embodiment of the invention, the terminating call routing information 606 sent by HLR/VLR 108 includes not only the terminating call routing information for routing the call to the MSC-A/VLR 102A, but also the roaming area information that was previously stored therein before the MSC-A/VLR 102 restart and reload occurred. The TMSC 602 uses the routing information to route the incoming call by sending the IAM 608, which now includes the roaming area information therein, to the MSC-A/VLR 102A. The MSC-A/VLR 102 may thereafter use the roaming area information carried in the IAM 608 to issue a primary page for the appropriate mobile terminal 110, and the call may completed in a manner similar to that described above.

In a preferred embodiment, the terminating call routing retrieval message and the terminating call routing message are MAP-based messages (solid lines), examples of which will be described later herein.

FIG. 6B illustrates an embodiment of the invention wherein incoming calls from the PSTN or PLMN are routed through a Gateway MSC (GMSC), which can be essentially any MSC in the network 100. The GMSC/MSC 610 receives the IAM 600 and subsequently requests routing information via a terminating call routing retrieval message 604 to the HLR/GLR 108. The HLR/GLR 108 responds by sending the terminating call routing information 606 together with the roaming area information to the GMSC/MSC 610. The GMSC/MSC 610 thereafter uses the routing information to route the call by sending the IAM 608, which now includes the roaming area information therein, to MSC-A/VLR 102A.

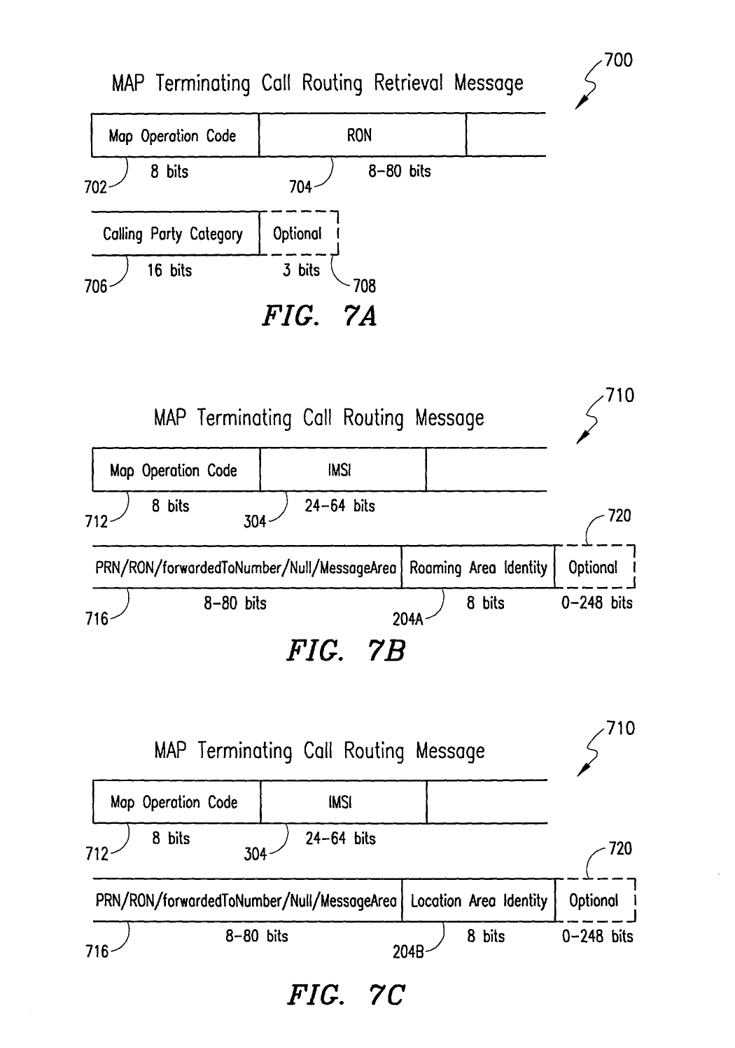

As mentioned above, the terminating call routing retrieval message and the terminating call routing message (604 and 606) may be MAP-based messages in a preferred embodiment. FIGS. 7A-7C illustrate examples of such MAP-based messages. Referring to FIG. 7A, a standard MAP terminating call routing retrieval message 604 includes 8 bits of MAP operation code 702, 8-80 bits of a Roaming Number (ROM) 704 for the mobile terminal, 16 bits for the calling party category 706, and 3 bits of optional information 708.

FIGS. 7B and 7C illustrate an exemplary MAP terminating call routing message 606, according to one embodiment of the present invention, including 8 bits of MAP operation code 712; 24-64 bits of IMSI 304; 8-80 bits of routing information 716 including the Pursuit Roaming Number (PRN), RON, forwardToNumber, a Null, and a Message Area; 8 bits of roaming area information 204; and 0-248 bit of optional information 720. In FIG. 7B, the roaming area information is realized as a Roaming Area Identity 204A of the particular roaming area where the mobile terminal 110 is located. Alternatively, in FIG. 7C, the roaming area information is realized as a Location Area Identity (LAI) 204B for the particular location area of the roaming area of the service area where the mobile terminal is located.

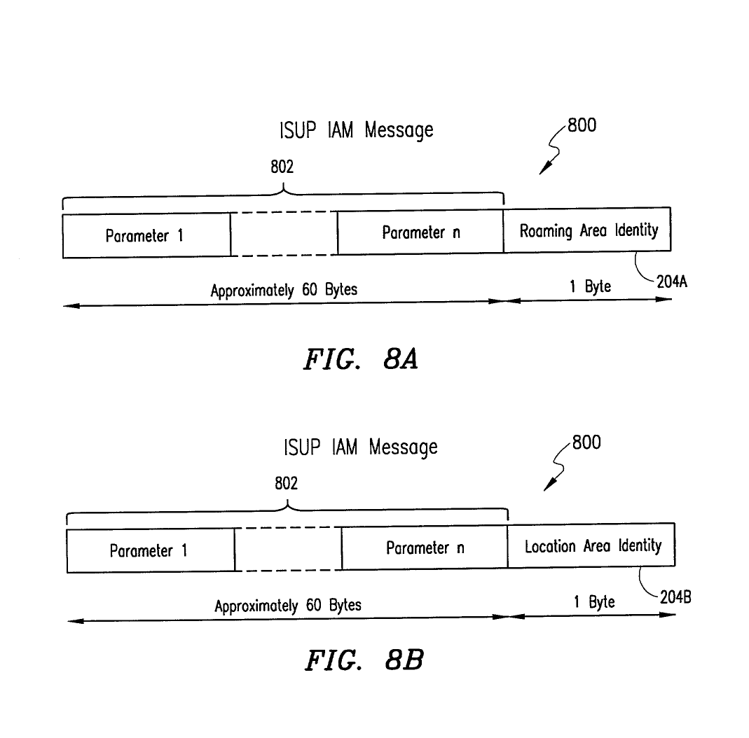

FIGS. 8A and 8B illustrate an exemplary ISUP IAM message 608, according to one embodiment of the present invention, including approximately 60 bytes of incoming call parameters 802 (parameters 1 through ‘n’) and one byte of roaming area information 204. In FIG. 8A, the roaming area information is realized as a Roaming Area Identity 204A of the particular roaming area where the mobile terminal 110 is located. Alternatively, in FIG. 8B, the roaming area information is realized as a Location Area Identity (LAI) 204B for the particular location area of the roaming area of the service area where the mobile terminal is located.

Such an arrangement as described in the foregoing preferred exemplary embodiments allows a primary page to be used instead of a global page to locate the mobile terminal after a system restart and reload when the MSC/VLR has no record of the mobile terminal's current roaming area. As a result, significantly fewer global pages are required to locate the mobile terminal after such a system restart and reload, thereby reducing the amount of bandwidth and processing resources consumed.

By way of example, for a roaming area having, say, six location areas therein, the use of primary paging will consume only about 20% of the network processing capacity consumed by global paging. Furthermore, primary paging after a VMSC system restart and reload will reduce paging congestion, thus the paging queue occupancy of the network is reduced to around 20% of the paging queue occupancy required for global paging.

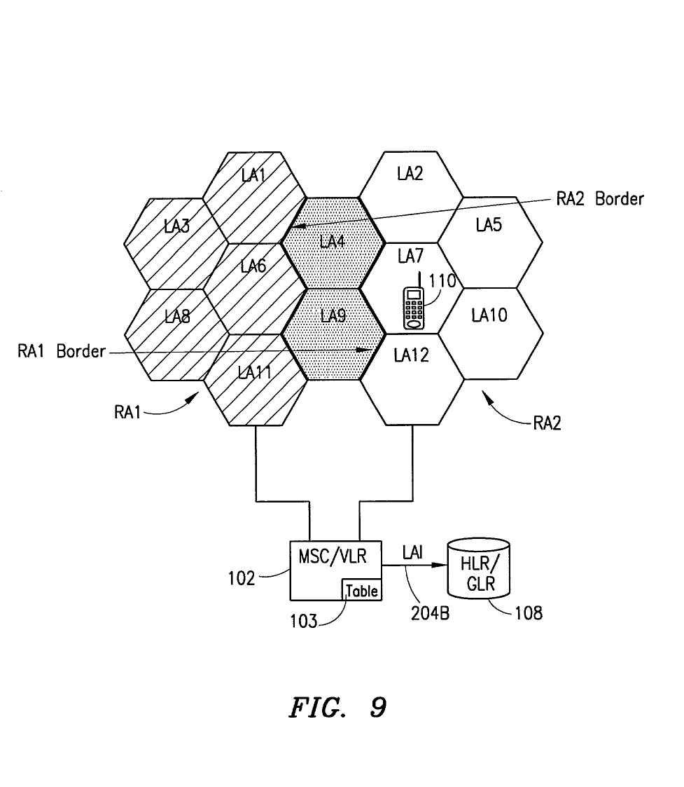

FIG. 9 illustrates an embodiment of the present invention where adaptive roaming areas (only four of which RA1-RA4 are shown) are used. The roaming areas RA1 and RA2 shown in FIG. 9 overlap each other such that each roaming area, i.e. RA1, overlaps neighboring roaming areas, i.e., RA2. Looking at an entire service area, the overlap may be up to 100% (not shown). If the overlap is 100%, there are as many roaming areas RA as there are location areas LA.

When the MSC/VLR 102 determines that the mobile terminal 110 has entered a new location area, such as LA7, within a new roaming area RA2, the mobile terminal 110 is located near the middle of the new roaming area RA2. This provides an additional advantage of being more likely to find the mobile terminal 110 in the event of a system shutdown (since the mobile terminal's 110 last known location area LA7 was located near the center of the roaming area RA2, and the likelihood of the mobile terminal 110 moving to a new roaming area, i.e., RA1, is small).

In this embodiment, the roaming area information 204 sent by the MSC/VLR 102 to the HLR/GLR 108 is the location area (i.e., LAI 204B) of the mobile terminal 110. Upon a system restart or when the mobile terminal 110 does not respond to a page within the location area, i.e., LA7, stored within the MSC/VLR 102, the LAI 204B (either provided by the HLR/GLR 108 or stored within the MSC/VLR 102 if the mobile terminal 110 is simply not responding to a location area page) is used by the MSC/VLR 102 to determine the roaming area RA2 by accessing the table 103 of roaming areas and associated location areas therein. Thereafter, the roaming area RA2 is used by the MSC/VLR 102 for primary paging purposes.

Although specific embodiments of the method and system of the present invention have been illustrated in the accompanying drawings and described in the foregoing detailed description, it will be understood that the invention is not limited to the embodiments disclosed, but is capable of numerous rearrangements, modifications and substitutions without departing from the spirit of the invention as set forth and defined by the following claims.

What is claimed is:

1. A method of locating a mobile terminal in a mobile communications network, the method comprising the steps of:
detecting when said mobile terminal has entered a new roaming area, said new roaming area being comprised of two or more location areas, each of said two or more location areas being comprised of one or more cells;
obtaining roaming area information of said new roaming area;
storing said roaming area information in a database; and
primary paging said mobile terminal within said new roaming area using said roaming area information stored in said database.

2. The method according to claim 1, wherein said new roaming area is within a current mobile switching center service area.

3. The method according to claim 2, wherein said step of storing includes sending a update subscriber data message having said roaming area information to said database.

4. The method according to claim 3, wherein said update subscriber data message is based on a mobile applications protocol.

5. The method according to claim 3, further comprising receiving an update subscriber acknowledgment or negative acknowledgment message from said database.

6. The method according to claim 1, wherein said new roaming area is within a new mobile switching center service area.

7. The method according to claim 6, wherein said step of storing includes sending a subscriber data request message having said roaming area information to said database.

8. The method according to claim 7, wherein said subscriber data request message is based on a mobile applications protocol.

9. The method according to claim 1, further comprising retrieving said stored roaming area information from said database.

10. The method according to claim 9, wherein said retrieving step includes receiving a subscriber data message including said stored roaming area information from said database.

11. The method according to claim 10, wherein said subscriber data message is based on a mobile applications protocol.

12. The method according to claim 9, wherein said retrieving step includes receiving a terminating call routing message including said stored roaming area information from said database.

13. The method according to claim 12, wherein said terminating call routing message is based on a mobile applications protocol.

14. The method according to claim 12, wherein said roaming area information is subsequently included in an initial address message of an ISUP message.

15. The method according to claim 1, wherein said roaming area information includes a roaming area identity.

16. The method according to claim 1, wherein said roaming area information includes a location area identity.

17. The method according to claim 1, wherein said database includes a home location register.

18. The method according to claim 1, wherein said database includes a guest location register.

19. The method according to claim 1, wherein said database includes a mobile switching center/visitor location register.

20. The method according to claim 1, wherein said step of detecting includes detecting when said mobile terminal enters a new location area, said new location area being associated with said new roaming area.

21. The method according to claim 20, wherein said new location area is within the middle of said new roaming area.

22. A system for locating a mobile terminal in a mobile communications network, comprising:
a mobile switching center adapted to detect when said mobile terminal has entered a new roaming area and to obtain a roaming area information of said new roaming area, said new roaming area being comprised of two or more location areas, each of said two or more location areas being comprised of one or more cells; and
a database connected to said mobile switching center and configured to store said roaming area information; wherein
said mobile switching center is further adapted to issue a primary page for said mobile terminal within said new roaming area using said roaming area information stored in said database.

23. The system according to claim 22, wherein said mobile terminal is already known in a service area of said mobile switching center.

24. The system according to claim 23, wherein said mobile switching center is further adapted to send a update subscriber data message including said roaming area information to said database.

25. The system according to claim 24, wherein said update subscriber data message is based on a mobile applications protocol.

26. The system according to claim 24, wherein said database is further configured to send an update subscriber acknowledgment or negative acknowledgment message to said mobile switching center.

27. The system according to claim 22, wherein said mobile terminal is new in a service area of said mobile switching center.

28. The system according to claim 27, wherein said mobile switching center is further adapted to send a subscriber data request message including said roaming area information to said database.

29. The system according to claim 28, wherein said subscriber data request message is based on a mobile applications protocol.

30. The system according to claim 23, wherein said database is further configured to send said stored roaming area information back to said mobile switching center.

31. The system according to claim 30, wherein said stored roaming area information is sent back to said mobile switching center in a subscriber data message.

32. The system according to claim 31, wherein said subscriber data message is based on a mobile applications protocol.

33. The system according to claim 22, wherein said database sends said roaming area information to a transit mobile switching center via a terminating call routing message.

34. The system according to claim 33, wherein said terminating call routing message is based on a mobile applications protocol.

35. The system according to claim 33, wherein said roaming area information is subsequently included in an initial address message of an ISUP message.

36. The system according to claim 22, wherein said database sends said roaming area information to a gateway mobile switching center via a terminating call routing message.

37. The system according to claim 36, wherein said terminating call routing message is based on a mobile applications protocol.

38. The system according to claim 36, wherein said roaming area information is subsequently included in an initial address message of an ISUP message.

39. The system according to claim 22, wherein said roaming area information includes a roaming area identity.

40. The system according to claim 22, wherein said roaming area information includes a location area identity.

41. The system according to claim 22, wherein said database includes a home location register.

42. The system according to claim 22, wherein said database includes a guest location register.

43. The system according to claim 22, wherein said database is said mobile switching center.

44. The system according to claim 22, wherein said mobile switching center detects when said mobile terminal enters a new location area, said new location area being associated with said new roaming area.

45. The system according to claim 44, wherein said new location area is within the middle of said new roaming area.
